(19) United States
(12) Patent Application Publication
(10) Pub. No.: US 2009/0315807 A1
(43) Pub. Date: Dec. 24, 2009

(54) MULTI-DISPLAY OPERATING SYSTEM AND METHOD THEREOF

(75) Inventor: Fan-Hsuan Hsu, Taipei (TW)

Correspondence Address: PEARNE & GORDON LLP, 1801 EAST 9TH STREET, SUITE 1200, CLEVELAND, OH, 44114-3108, US

(73) Assignee: ACER INCORPORATED, Taipei (TW)

(21) Appl. No.: 12/484,420

(22) Filed: Jun. 15, 2009

(30) Foreign Application Priority Data
Jun. 19, 2008 (TW) 097122948

(51) Int. Cl. G09G 5/00

(52) U.S. Cl. 345/1.3

(57) ABSTRACT

This present invention discloses a multi-display operating system and method thereof, which are applied to operate a plurality of screens respectively displayed on a plurality of display apparatuses, and these screens respectively display the interface image of at least one application program. The invention is characterized in that a focused screen is decided from these screens based on the location of a cursor on these screens or a focus switching signal, and then the operating signal inputted from the user will be only transmitted to the application program which is displayed on the focused screen, and only audio signal generated by the application program displayed on the focused screen will be outputted. Besides, the user also can choose two screens to swap. Therefore, the multi-display operating system and its method in accordance with the present invention allow users to operate the application programs displayed on the multiple screens more efficiently.

### BACKGROUND OF THE INVENTION

1. Field of the Invention

The present invention relates to a multi-display operating system and method thereof, in particular, the present invention relates to a multi-display operating system capable of generating focused screens and method thereof.

2. Description of Related Art

Refer to FIG. 1, wherein an architectural diagram for the generation of extended screens in a prior art display system is shown. In the Figure, the display system includes an image processing unit 11, a display memory 12, a display drive unit 13 and a display output unit 14. The illustrated display system is capable of showing a main screen and an extended screen, so the display memory 12 accordingly allocates a first area 121 and a second area 122. If the display system intends to show more screens, then the display memory 12 can allocate the number of areas corresponding to the number of screens therefore. The image processing unit 11 generates first image data 111 and second image data 112, which are respectively stored in the first area 121 and the second area 122. The display drive unit 13 and the display output unit 14 both continuously read data images from the first area 121 and the second area 122 at a preset frequency (e.g. 30 Hz). If such a display system is used in a notebook computer, then the display drive unit 13 drives a Liquid Crystal Display (LCD) to show the read first image data 111. The display output unit 14 transfers the read second image data 121 to an external display apparatus for rendering.

Refer to FIG. 2, wherein a diagram for a prior art multi-display operating system is shown. In the Figure, a user generates a main screen 211 as well as three extended screens 212, 213 and 214 respectively displayed on the screen 221 of a notebook computer and three external displays 222, 223 and 224. Logically, the main screen and these three extended screens can be considered as four portions of a grand screen, and the interface images of the application programs executed by the user are shown in such a grand screen. The user may arbitrarily move interface images of these application programs to different screens, e.g. the window images 231˜239 respectively shown by the screen 221 and external displays 222, 223 and 224. Besides, not only within one single screen, the mouse cursor 28 is also allowed to move among these screens. Hence, so long as the image process ability in the notebook computer of the user is sufficiently powerful, enabling acceptable rendering for four screens in real-time, then the user can benefit from such a multi-display feature. For example, the screen 221 displays a word processing program, the external display 222 shows an audio/video player program, the external display 223 presents a network browser and the external display 224 renders a messaging communication program, thus allowing to prevent the drawback of undesirable overlapping of multiple program interface images when running multiple programs on one single screen, thereby improving the efficiency for information browsing.

While using such a multi-display operating system, users typically execute several programs for exploiting the advantage of multi-display function. However, in a prior art multi-display operating system, as the user executes more programs, program switching tends to become gradually complicated and troublesome. In the program switching diagram 29 shown in FIG. 2, which illustrates a program switching diagram 29 occurred upon pressing down Alt-Tab buttons by a user under the Windows operating system, all currently running programs 231˜239 are listed to allow the user to switch among them. As more programs being executed, the icons shown in the program switching diagram 29 may become excessive, resulting in possible erroneous switching actions performed by the user.

### SUMMARY OF THE INVENTION

The objective of the present invention is to provide a multi-display operating system and method thereof so as to improve the efficiency of multi-display operations by the user.

According to the objective of the present invention, a multi-display operating system for operating the screens shown on a plurality of display apparatuses is provided. The multi-display operating system comprises a processing module, a display module, an input module and an operation focus control module. The processing module executes a plurality of application programs. The display module generates a plurality of screens which are respectively shown on each of the display apparatuses. The interface images of these running application programs are respectively shown on each of the screens. The input module receives an operating signal, and the operation focus control module selects one focused screen among these screens and then transfers the operating signal to the application program displayed on the focused screen.

Additionally, the multi-display operating system further comprises an audio processing module, in which the operation focus control module controls the audio processing module to output the audio signals only generated by the application program shown on the focused screen.

Besides, the multi-display operating system further comprises a cursor operation module used for manipulating the cursor shown on these screens, and the operation focus control module determines the focused screen based on the location of the cursor.

Herein the input module receives a focus switching signal, and the operation focus control module determines the focused screen based on the focus switching signal.

Besides, the multi-display operating system further comprises a screen swap module, in which the user may choose two of these screens by means of the input module, and the screen swap module can be used to swap the application programs shown on these two selected screens.

Moreover, the screen swap module may further swap the displays of the two selected screens among these display apparatuses.

Furthermore, the present invention further provides a multi-display operating method for manipulating the screens shown on a plurality of display apparatuses. The multi-display operating method comprises the following steps: initially, generating a plurality of screens, and displaying respectively these screens on such display apparatuses; showing respectively the interface images of different application programs on these screens; then selecting a focused screen among these screens, and upon reception of an operating signal, transferring the operating signal to the application program displayed on the focused screen.

Herein the multi-display operating method further comprises a step of outputting the audio signals only generated by the application program shown on the focused screen.

Herein the multi-display operating method further comprises a step of determining the focused screen based on the location of the cursor on these screens.

Herein the multi-display operating method further comprises a step of receiving a focus switching signal, and determining the focus screen based on the received focus switching signal.

Herein the multi-display operating method further comprises a step of selecting two of these screens and swapping the application programs shown on the selected two screens.

Herein the multi-display operating method further comprises a step of swapping the displays of the two selected screens between these display apparatuses.

### BRIEF DESCRIPTION OF THE DRAWINGS

FIG. 1 depicts an architectural diagram for the generation of extended screens in a prior art display system;

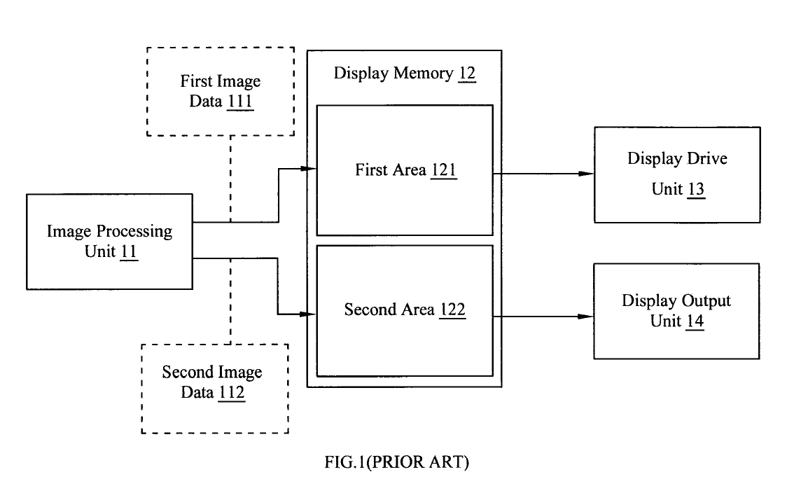

FIG. 2 depicts a diagram of a prior art multi-display operating system;

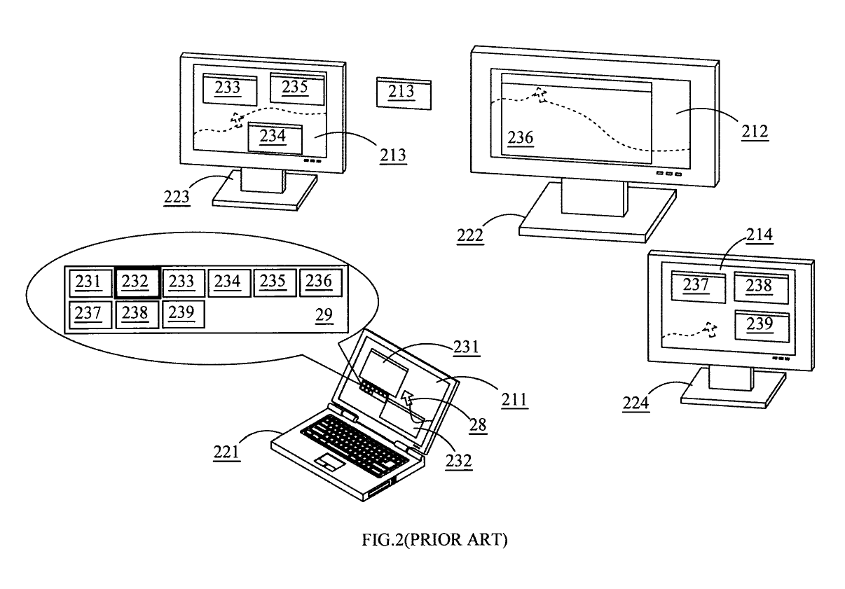

FIG. 3 depicts a block diagram for an embodiment of the multi-display operating system according to the present invention;

FIG. 4 depicts a block diagram for another embodiment of the multi-display operating system according to the present invention;

FIG. 5 depicts a stepwise flowchart for an embodiment of the multi-display operating method according to the present invention; and

FIG. 6 depicts a stepwise flowchart for an embodiment of executing a screen swap in the multi-display operating method according to the present invention.

### DETAILED DESCRIPTION OF THE PREFERRED EMBODIMENTS

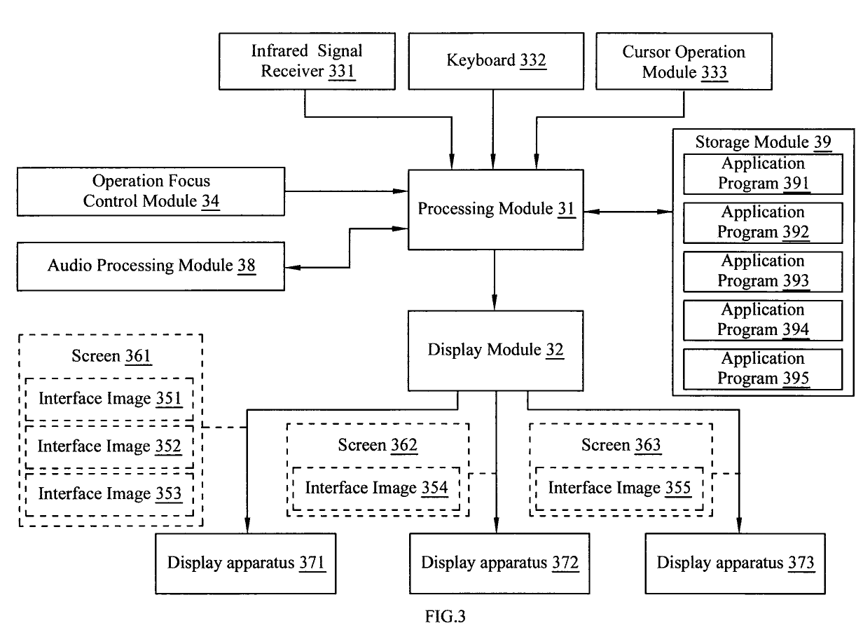

Refer to FIG. 3, wherein a block diagram for an embodiment of the multi-display operating system according to the present invention is shown. As depicted, the multi-display operating system comprises a processing module 31, a display module 32, an input module, an operation focus control module 34, an audio processing module 38 and a storage module 39. The storage module 39 is used to store a plurality of application programs 391˜395, and the processing module 31 reads the plurality of application programs 391˜395 from the storage module 39 and executes them. The display module 32 comprises at least an image processing unit, a display memory, a display drive unit and a display output unit. As shown in FIG. 3, the display module 32 generates a plurality of screens 361˜363 which are respectively shown on a plurality of display apparatuses 371˜373, and the interface images 351˜355 of the application programs 391˜395 are respectively shown on these screens 361˜363.

The input module comprises an infrared (IR) signal receiver 331, a keyboard 332 and a cursor operation module 333. The IR signal receiver 331 is used to receive an IR signal emitted from a remote controller, analyze the operation command from the received IR signal, and transfer the operation command to the processing module 31. The keyboard 332 allows the user to enter texts and commands. The cursor operation module 333 allows the user to input location data and a press-down signal, in which the location data is transferred to the processing module 31, and the processing module 31 changes the display location of the cursor on the screen based on the received location data and then determines whether to activate the application program according to the press-down signal and the location of the cursor. Thereby, the user is capable of manipulating the cursor displayed on the screens 361˜363 by means of the cursor operation module 333 and operating the application program. The cursor operation module 333 can be a mouse or a touch panel.

The operation focus control module 34 chooses the focused screen among the screens 361˜363 in accordance with the following approaches:

(1) the operation focus control module 34 may decide the focused screen based on the location of the cursor. Logically, the screens 361˜363 can be deemed as three portions of a grand screen, so the operation focus control module 34 can determine the screen on which the cursor is currently hovering by means of the location of the cursor. Since the user commonly operates the application program by controlling the cursor, the screen on which the cursor is located can be thus considered as the screen the user is now concerning or executing, so the operation focus control module 34 can decide the focused screen based on the location of the cursor;

(2) when the IR signal receiver 331 or the keyboard 332 receives a focus switching signal, it indicates that the user is operating the remote controller or pressing down a specific button on the keyboard, and then the operation focus control module 34 may decide the focused screen in accordance with such a focus switching signal; for example, it is possible to switch the focused screen in a sequence of screen 361→screen 362→screen 363. When the current focused screen is the screen 361, then upon reception of the focus switching signal, the operation focus control module 34 will switch to the screen 362 as the focused screen.

The operation focus control module 34 can use the above-illustrated two approaches individually for focused screen selection, or both.

After determination of the focused screen, when the keyboard 332 or the IR signal receiver 331 receives the operation command, the received command will be transferred to the application program only displayed on the focused screen. Furthermore, the operation focus control module 34 also controls the audio processing module 38 to output the audio signals only generated by the application program shown on the focused screen. For example, the application program 394 is a TV playback program, and the application programs 391˜393 are text processing programs. When the screen 361 is the focused screen, the audio processing module 38 outputs only the audio signals from the text processing program, rather than the sound from the TV playback program. However, as the screen 362 becomes the focused screen, the audio processing module 38 doesn't outputs the audio signals from the text processing program at this moment, but only the sound from the TV playback program. In this way, the user is easy to appreciate which screen is the current focused screen, and it can prevent the drawback found in the prior art that audio outputs from all application programs are mixed together, which may confuse the user thus causing incorrect distinction.

In addition, the aforementioned multi-display operating system may further comprise a screen swap module according to the needs, and the user selects two screens among these screens 361˜363 by means of the input module, and then the screen swap module is used to swap the application programs shown on the two selected screens or to swap displays of the selected two screen among such display apparatuses. For example, if the user chooses the screens 361 and 362 as screens to be swapped, then upon triggering the screen swap module by the user, two possible modes may occur:

(a) first mode: a swap of application programs displayed on two screens; i.e., the interface images 351˜353 of the application programs 391˜393 are alternatively shown on the screen 362, while the interface images 354 of the application programs 394 are shown on the screen 361, but the screen 361 and the screen 362 are nonetheless displayed respectively on the original display apparatuses 371 and 372. In practice, this can be accomplished by modifying the window location data within the property description data of the application programs 391˜393. Before swapping, the screen swap module may optionally record the locations for such application programs, i.e. the location of the application program in its original screen, and when the user performs once again the swap, the application program can be restored to the original screen and the original location;

(2) second mode: a swap for displays of the two selected screens among such display apparatuses, that is, the screen 361 is alternatively shown on the display apparatus 372, the screen 362 is shown on the display apparatus 371, and then the application programs shown on the two screens are accordingly interchanged. Before swapping, the screen swap module may optionally record the display settings of these screens, such as screen resolution and color quality etc., as well as the locations of these application programs; so when the user performs once again the swap, the screen can be restored to its original settings.

Herein, in case the two screens chosen by the user are both the extended screens, it is preferable that the screen swap module performs the first mode. Whereas if the two screens selected by the user are the main screen and one extended screen, then it is preferable that the screen swap module performs the second mode.

It is also preferable that the aforementioned operation focus control module and the screen swap module are implemented through the execution of relevant program software by a processor. It should be noted that, in the present embodiment, three screens and five application programs are illustrated as examples. However, the present invention is by no means limited thereto, and all multi-display operating system capable of generating a plurality of screens and at least one application program are within the scope of the present invention.

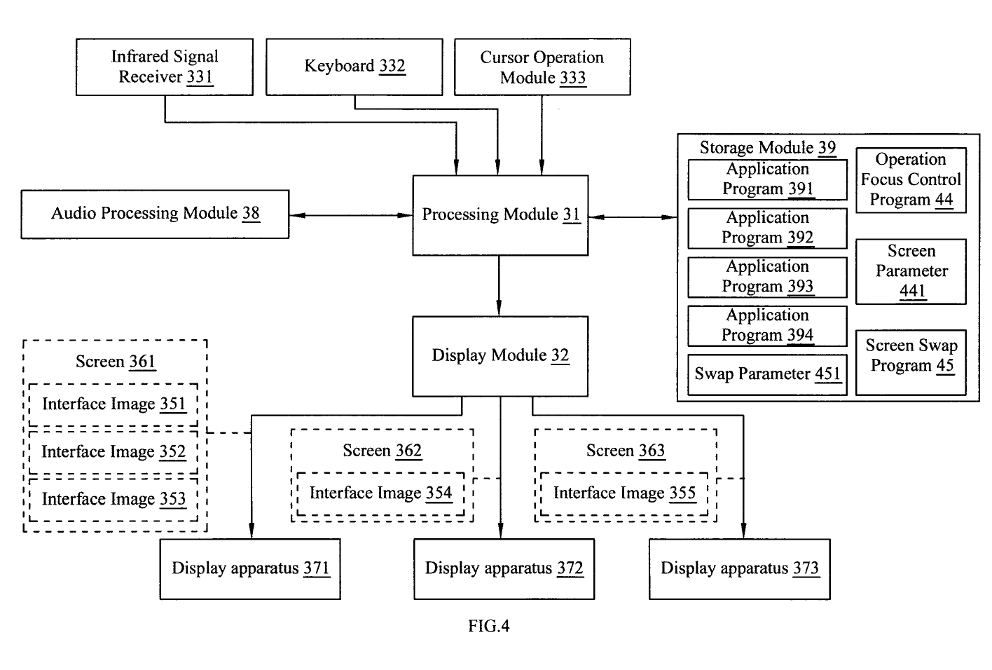

Refer to FIG. 4, wherein a diagram for another embodiment of the multi-display operating system according to the present invention is shown. The difference between the present embodiment and the aforementioned one lies in that the operation focus control module and the screen swap module are implemented as software. The storage module 39 further stores an operation focus control program 44 and a screen swap programs 45. The processing module 31 reads the operation focus control program 44 from the storage module 39 and executes it so as to identify the application program rendered on each screen, and chooses a focused screen and then stores the data indicating the focused screen as well as the representative data of the application program shown on each screen as the screen parameter 441. Logically, the main screen and the extended screens can be considered as portions of a grand screen, and the interface image of the application program executed by the user is displayed on the grand screen, so it is possible to determine on which screen the application program is currently shown according to the location of the interface image of the application program and then have them recorded in the screen parameter 441. Herein the screen parameter 441 is allowed to be utilized by other application programs; e.g. the application program in the program switching diagram appearing upon pressing down the Alt+Tab keys on the keyboard by the user can read the screen parameter 441, thereby it is possible to show only the icon representing the application program on the focused screen, eliminating thus the drawback of presenting excessive icons in the prior art which may cause unwanted trouble during switching operation. Besides, each application program can also record the displayed screen parameter thereof.

The processing module 31 reads the screen swap program 45 from the storage module 39 to swap the application programs shown on two selected screens, or to swap displays of these two selected screens among such display apparatuses. Before swapping, the screen swap program 45 records the location of the application program or the settings of the screen in the swap parameter 451. The swap parameter 451 can be also used by other application programs.

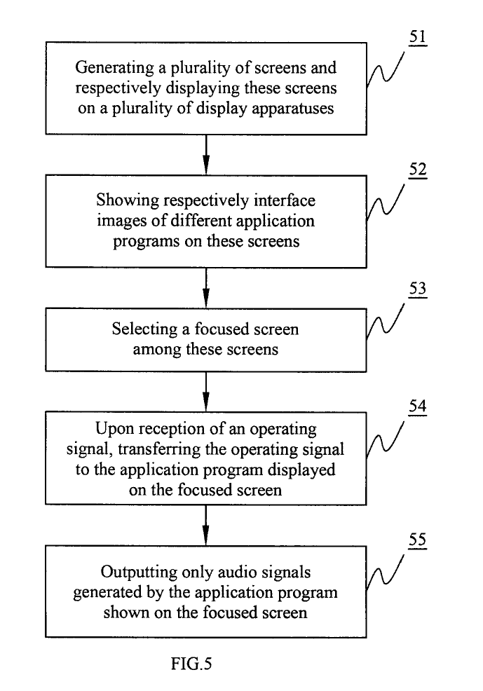

Refer to FIG. 5, wherein a stepwise flowchart for an embodiment of the multi-display operating method according to the present invention is shown. In the Figure, the multi-display operating method is used to operate the screens rendered on a plurality of display apparatuses. The method comprises the following steps: initially, in step S51, generating a plurality of screens, and individually showing these screens on such display apparatuses, herein these screens comprise a main screen and at least one extended screen; next, in step S52, individually showing the interface images of different application programs on these screens, and determining the screen representing the interface image thereof based on the location of the application program, recording them in the property description data of the application program, in which even if the user moves the interface image of the application program, it is still possible to determine and update the property description data in accordance with the location thereof; in step 53, selecting one focused screen from these screens. For example, it may decide the focused screen based on the location of the cursor hovering over these screens; or alternatively, by receiving a focus switching signal and determining the focused screen based on the focus switching signal.

Subsequently, in step 54, upon reception of an operating signal, such as the character entered from a keyboard operation by the user, transferring the operating signal to the application program shown on the focused screen, thereby the user may intuitively operate the application program displayed on the focus screen without worrying about whether the inputted operating signal erroneously operates on other irrelevant programs; next, in step S55, outputting only the audio signals generated by the application program shown on the focused screen. In practice, it is possible to set the application program shown on the focused screen as mute, e.g. passing the component code indicating the application program intended to be muted to the operating system, and configuring the application program corresponding to the component code to be mute via the operating system; or alternatively, it is possible to control the audio processing module of the system carrying out the present method to filter out the audio signals outputted from the application programs shown on non-focused screens.

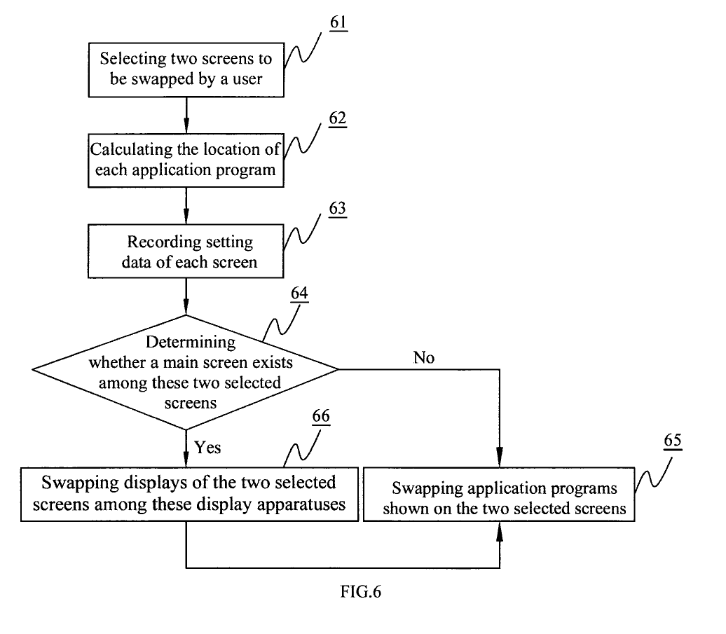

Refer next to FIG. 6, wherein a stepwise flowchart for an embodiment of executing a screen swap in the multi-display operating method according to the present invention is shown. The present embodiment illustrates the screens showing operations on a plurality of display apparatuses. In step 6 1, the user chooses two screens to be swapped. In step 62, it calculates the location of each application program and has it stored. In step 63, it records setting data for each screen, e.g. screen resolution and color quality etc. In step 64, it determines whether the main screen is chosen among the two selected screens; in case no main screen is selected, and then it swaps the application programs shown on the two selected screen in step 65, which can be accomplished, for example, through modifying the window location data in the property description data of the application program.

However, suppose one of the two selected screens is the main screen, in step 66 it first swaps displays of the two selected screens among such display apparatuses, and subsequently swaps the application programs shown on these two selected screens, as illustrated in step 65.

In case the user executes once again screen swapping, then the method can perform step 65 or step 66 in accordance with previously stored window location data or screen setting data. The present embodiment may further comprise provision of a register for storing the data indicating the current screen has been previously swapped. Suppose the user re-selects these two screens, then the settings thereof will be reset.

The aforementioned descriptions are simply exemplary, rather than being restrictive. All effectively equivalent modifications or changes made on the illustrated embodiments without departing from the scope and spirit of the present invention are deemed to be encompassed by the following claims.

What is claimed is:

1. A multi-display operating system applicable to operate screens shown on a plurality of display apparatuses, the multi-display operating system comprising:
a processing module executing a plurality of application programs;
a display module generating a plurality of screens, the screens being respectively shown on each of the display apparatuses, and interface images of the application programs being respectively shown on each of the screens;
an input module receiving an operating signal; and
an operation focus control module selecting one focused screen among the screens and transfering the operating signal to the application program displayed on the focused screen.

2. The multi-display operating system according to claim 1, further comprising an audio processing module being controlled by the operation focus control module to output only audio signals generated by the application program shown on the focused screen.

3. The multi-display operating system according to claim 1, further comprising a cursor operation module applicable to operate a cursor displayed on the screens, and the focused screen being determined by the operation focus control module based on a location of the cursor.

4. The multi-display operating system according to claim 1, wherein the input module receives a focus switching signal, and the operation focus control module determines the focused screen based on the focus switching signal.

5. The multi-display operating system according to claim 1, wherein the screens comprise a main screen and at least one extended screen.

6. The multi-display operating system according to claim 1, further comprising a screen swap module, in which a user selects two of the screens by the input module and the screen swap module is used to swap the application programs shown in the two selected screens.

7. The multi-display operating system according to claim 6, wherein the screen swap module records locations of the application programs before having the application programs swapped.

8. The multi-display operating system according to claim 6, wherein the screen swap module swaps displays of the two selected screens among the display apparatuses.

9. The multi-display operating system according to claim 8, wherein the screen swap module records display setting data of the screens before having the screens swapped.

10. A multi-display operating method applicable to operate screens shown on a plurality of display apparatuses, the multi-display operating method comprising:
generating a plurality of screens, and displaying the screens on the display apparatuses respectively;
showing interface images of different application programs on the screens respectively;
selecting a focused screen among the screens; and
upon reception of an operating signal, transferring the operating signal to the application program displayed on the focused screen.

11. The multi-display operating method according to claim 10, further comprising outputting only audio signals generated by the application program shown on the focused screen.

12. The multi-display operating method according to claim 10, wherein the step of selecting the focused screen further comprising:
determining the focused screen based on a location of a cursor displayed on the screens.

13. The multi-display operating method according to claim 10, wherein the step of selecting the focused screen further comprising:
receiving a focus switching signal; and
determining the focused screen based on the focus switching signal.

14. The multi-display operating method according to claim 10, wherein the screens comprise a main screen and at least one extended screen.

15. The multi-display operating method according to claim 10, further comprising:
selecting two of the screens; and
swapping the application programs shown on the two selected screens.

16. The multi-display operating method according to claim 15, further comprising:
recording locations of the application programs before having the application programs swapped.

17. The multi-display operating method according to claim 15, further comprising:
swapping displays of the two selected screens among the display apparatuses.

18. The multi-display operating method according to claim 17, further comprising:
recording display setting data of the screens before having the screens swapped.
